(19) United States
(12) Patent Application Publication
(10) Pub. No.: US 2012/0297736 A1
(43) Pub. Date: Nov. 29, 2012

(54) IN-LINE PRODUCTION OF A CARDBOARD CONTAINER

(75) Inventor: Steven Ausnit, New York, NY (US)

(73) Assignee: ILLINOIS TOOL WORKS INC., Glenview, IL (US)

(21) Appl. No.: 13/306,093

(22) Filed: Nov. 29, 2011

Related U.S. Application Data
(60) Provisional application No. 61/417,643, filed on Nov. 29, 2010.

(51) Int. Cl. B31B 17/00; B65B 43/10; B31B 17/26; B65B 11/48; B31B 17/60; B31B 17/14

(52) U.S. Cl. 53/456; 493/393; 493/377; 493/343; 53/462; 493/56

(57) ABSTRACT

Cartons with semi-rigid or rigid box-like container sections, along with attached plastic or polymeric reclosable flexible material structures, are disclosed. The resulting containers with reclosable flexible material are intended to be formed so as to be easily filled and closed. Furthermore, methods and apparatus for the manufacture of these cartons are disclosed.

This application claims priority under 35 U.S.C. §119(e) of U.S. provisional application Ser. No. 61/417,643, filed Nov. 29, 2010, the disclosure of which is hereby incorporated by reference in its entirety.

### BACKGROUND OF THE DISCLOSURE

1. Field of the Disclosure

This disclosure pertains to a container or carton with a semi-rigid or rigid box section with a reclosure header from flexible web reclosure material and an unfolded box blank that has top and side panels and bottom flaps to form the box bottom. The disclosure further relates to the method and machinery used in the manufacture thereof.

2. Description of the Prior Art

In the prior art, the use of a plastic flexible header and reclosure in combination with a rigid or semi-rigid box structure is a developing field. The container, as well as the machinery and method for the production thereof, is disclosed in U.S. patent application Ser. Nos. 12/922,537; 12/922,540; 12/922,541; and 12/922,547, all entitled “Carton with Plastic Reclosable Header” and filed on Sep. 14, 2010, the disclosures of all of which are hereby incorporated by reference. While the container, as well as the machinery and method of production thereof, has been found to be satisfactory and well-adapted to its intended purposes, further improvements are sought, particularly with regard to the shape and type of the resulting package.

### OBJECTS AND SUMMARY OF THE DISCLOSURE

It is therefore an object of the present disclosure to improve the container of the type with a rigid or semi-rigid box structure in combination with a plastic header and a reclosable zipper.

It is therefore a further object of the present disclosure to provide a container of the type described above with an alternate improved shape and stackability.

These and other objects are attained by providing web reclosure material and an unfolded flat box blank that has top and side panels and bottom flaps to form the box bottom, where one panel of the box blank has a cut-out and attaching over the panel web reclosure material, after which the box blank with the attached web reclosure material is separated into individual units. Thereafter, the box blank can be folded and formed into the resulting container with a reclosure header (and filled, when required) and wherein the reclosure header is attached to only one or an uneven number of sides of the box.

### BRIEF DESCRIPTION OF THE DRAWINGS

Further objects and advantages of the disclosure will become apparent from the following description and from the accompanying drawing, wherein:

FIG. 1 is a side schematic of an embodiment of the machinery and apparatus of the present disclosure.

FIG. 2 is a top schematic of an embodiment of the machinery and apparatus of the present disclosure.

FIG. 3 is a side schematic of a further embodiment of the machinery and apparatus of the present disclosure.

FIG. 4 is a top schematic of a further embodiment of the machinery and apparatus of the present disclosure.

FIG. 5A illustrates an alternate assembly of an embodiment of the unfolded flat blanks and web reclosure material of the present disclosure.

FIG. 5B is a cross-sectional view along plane 5B-5B of FIG. 5A.

FIG. 6A is a side schematic of a further embodiment of the machinery and apparatus of the present disclosure.

FIG. 6B is a top schematic of a further embodiment of the machinery and apparatus of the present disclosure.

FIG. 7 is a further schematic of the embodiment of the machinery and apparatus shown in FIGS. 6A and 6B.

FIG. 8 is a further schematic illustrating the filling process of inverted containers in an embodiment of the present disclosure.

FIGS. 9A through 9F are perspective views of various embodiments of the cardboard container of the present disclosure.

FIG. 10A is a perspective view of a still further embodiment of the cardboard container of the present disclosure.

FIG. 10B is a perspective view of the cardboard container of FIG. 10B, shown with a folded header.

FIG. 10C is a cross-sectional view of the cardboard container of FIG. 10A.

FIG. 10D is a partial cross-sectional view of the cardboard container of FIG. 10B, showing the zipper sealed to the outside of the folded film.

FIG. 10E is a partial cross-sectional view of the cardboard container of FIG. 10B, showing the zipper sealed to the inside of the folded film.

FIGS. 11A and 11B are perspective views showing the order of assembly of a cardboard container of the present disclosure.

FIG. 12A is a plan view of an embodiment of the unfolded box blank with attached web reclosure material of the present disclosure.

FIG. 12B is a plan view illustrating the assembly step of the cardboard container of FIG. 12A.

FIG. 13A is a diagram of a portion of the assembly method and apparatus of an embodiment of the reclosable material of the present disclosure.

FIGS. 13B, 13C and 13D are cross-sectional diagrams of the engagement of the zipper or reclosure mechanism in an embodiment of the present disclosure.

FIG. 14A is a diagram of a portion of an alternative assembly method and apparatus of the web reclosure material of the present disclosure.

FIG. 14B is a cross-sectional diagram of the engagement of the zipper or reclosure mechanism and web material of FIG. 14A in an alternative embodiment of the present disclosure.

FIGS. 15A through 15F are cross-sectional views of different arrangements of the web reclosure material to form a header.

FIG. 15G illustrates the method of assembly of an embodiment of the header of the present disclosure.

FIGS. 16A-16F are cross-sectional views illustrating further embodiments of the zipper structure of the present disclosure.

### DETAILED DESCRIPTION OF THE PREFERRED EMBODIMENTS

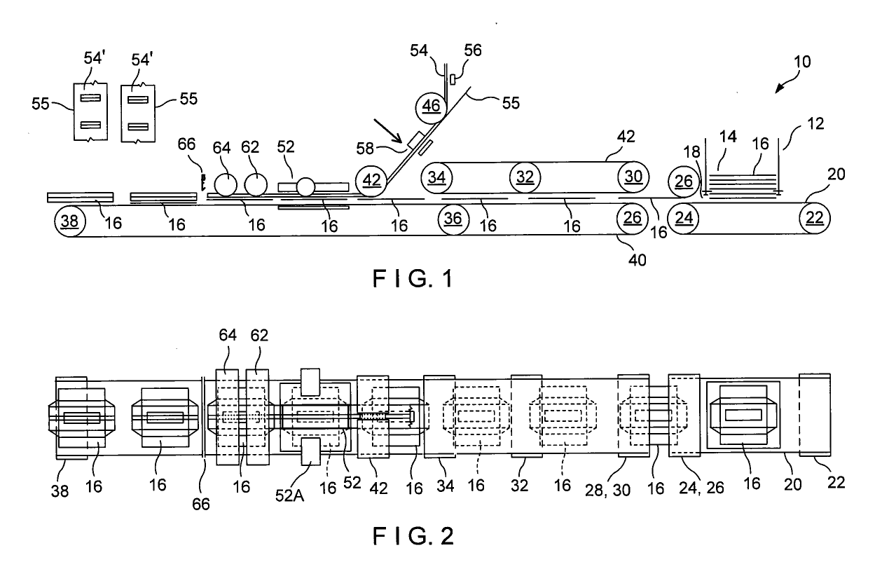

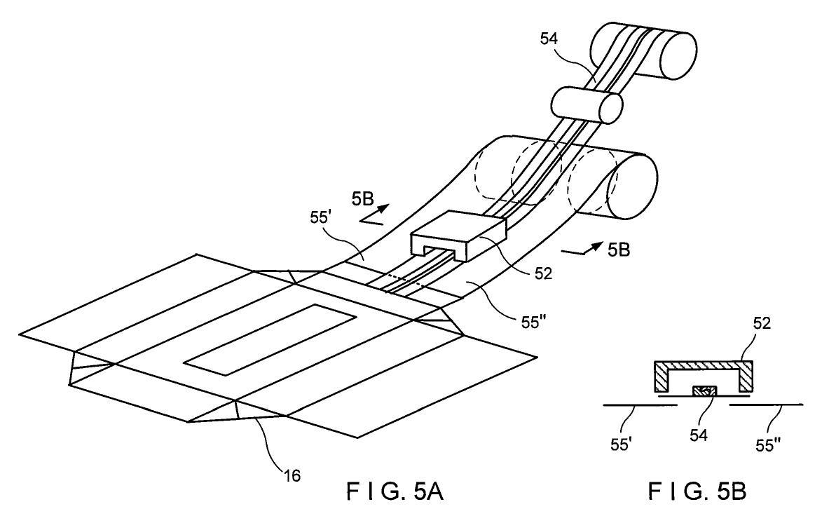

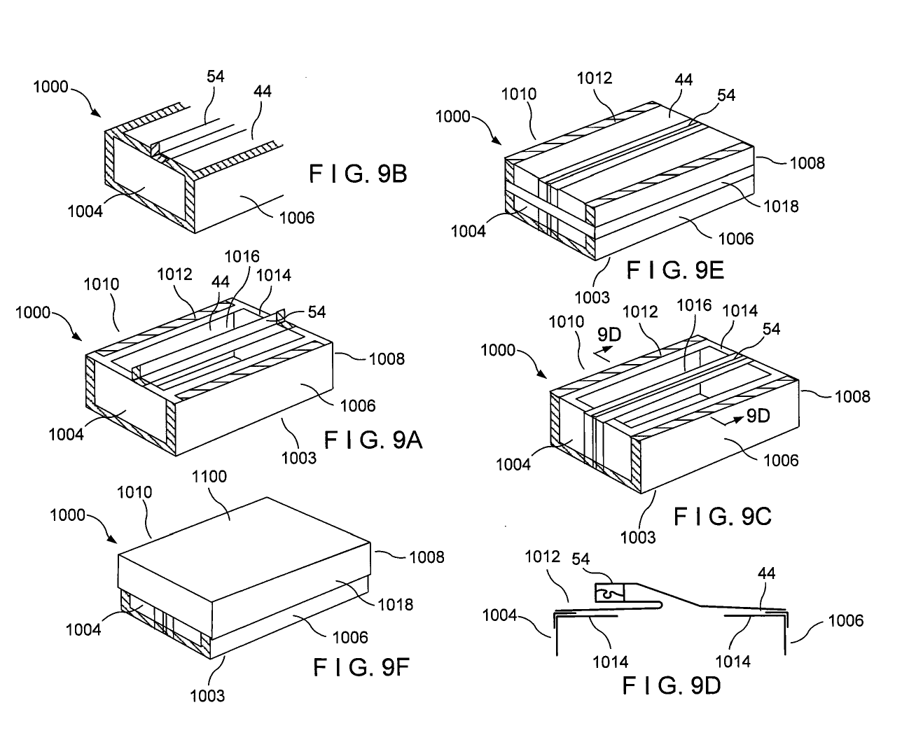

Referring now to the drawings in detail wherein like numerals indicate like elements throughout the several views, one can see that FIGS. 1 and 2 are respective top and side schematic views of a machinery and apparatus 10 for the production of cartons 1000, as illustrated hereinafter at FIGS. 9A-11B. Apparatus 10 includes a magazine 12 which holds a stack 14 of flattened unfolded blanks 16 (or rigid or semi-rigid unfolded flat box sections) which are eventually folded to form the semi-rigid or rigid box portions or panels 1002 (sides and bottom) of cartons 1000. Preferably, the blanks 16 have been cut and formed prior to being supplied to magazine 12, there are instances wherein the cut-out section area is perforated for removal of these sections later in the manufacturing process, such as after the attachment of the web reclosure material. A bottom feed belt 20, configured around rolls 22, 24 sequentially pulls a single blank 16 through the feed gate 18 which is formed at the bottom of the magazine 12. The feed gate 18 allows the thickness of only one blank 16 to pass through at a time. The series or sequence of blanks 16 progressing through apparatus 10 can be seen on both FIG. 1 and FIG. 2. The blanks 16 are passed by bottom feed belt 12 to the nip formed between rollers 24, 26 and further to the nip formed between rollers 28, 30 so as to be engaged between lower and upper main conveyor pull belts 40, 42. Lower main conveyor pull belt 40 is configured around rollers 28, 38. Similarly, upper main conveyor pull belt 42 is configured around rollers 30, 32, 34. Lower and upper main conveyor pull belts 40, 42 are set at a different speed from the bottom feed belt 20 so as to control and fix the gap between successive blanks 16. Alter the position of the blanks 16 has been adjusted, the blanks 16 are delivered to roller 42 where it is joined to polymeric web reclosure material 44. Web reclosure material 44 is formed from zipper 54 and web or film material 55 that are joined at roller 46 and attached to each other at sealing or attaching station 58. Zipper 54 may have sliders mounted on it at slider mounting station 56. Polymeric web reclosure material 44 is positioned over and held in place against the blanks 16. However, as shown in FIGS. 5A and 5B, other embodiments may join the blank 16, the web material 55 (illustrated as two separate sheets 55′ and 55″) and the zipper material 54 simultaneously. If the web reclosure material is delivered above the flat unfolded blanks 16 and attached thereto, the resulting combination typically will have to be inverted before filling. If the reclosable material is delivered below the blanks 16, typically no inversion is necessary.

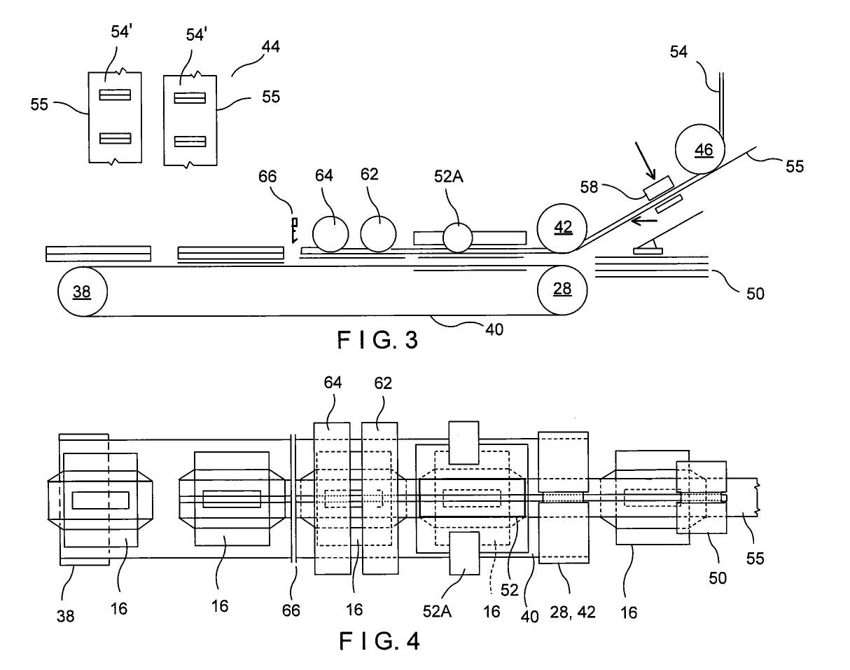

FIG. 1, as well as FIG. 3, further includes an inserts with illustrations of an alternative embodiments wherein the web reclosure material 44, instead of being provided with continuous zipper, is provided with pre-applied zipper sections or segments 54′, in either the machine or transverse direction, which are then indexed to fit over the blanks 16.

As shown in FIGS. 3 and 4, other methods of delivering the blank 16 to the (lower) main conveyor pull belt 40 may be used, such as positioning the blanks 16 on the conveyor pull belt 40 by vacuum pick-up and placing devices 50. In the embodiment of FIGS. 3 and 4, the blanks 16 could be delivered to the conveyor pull belt 40 from a location adjacent to the conveyor pull belt 40 rather than in-line with the conveyor pull belt 40.

In both the embodiments of FIGS. 1 and 2 and of FIGS. 3 and 4, the web reclosure material or film 44 is attached to the blanks 16, preferably by one or more seal bars 52. Alternately, this attachment may be done by adhesive and element 52 would be implemented as an adhesive applicator. Seal bar 52 would typically include at least one seal bar which is rectangular and would attach the web reclosure material 44 to the blank 16 in a single operation. Some applications, however, may require more than one operation. Seal bar 52 may be reciprocal and may travel horizontally, synchronized with the conveyor pull belt 40 and then return to seal the succeeding blank 16. This is typically more efficient than an intermittent (“stop-and-go”) travel of the conveyor pull belt 40 and typically provides more dwell time for the seal bar 52 thereby improving seal quality. At the location of seal bar 52, side rollers 52A move the unfolded blanks 16 and roller 62, synchronized to roller 52A, moves the web reclosure material 44.

After the web reclosure material 44 is sealed to the blank 16, the blanks 16 along with the attached reclosure material 44, are transported by conveyor pull belt 40 under rollers 62, 64, and a cross-seal is formed in the web reclosure material 44 and the web reclosure material 44 (which is still a continuous sheet connected to a series of blanks 16) is cut by cutter 66 (cutter 66 typically also forming the cross seal). The resulting cartons 1000 (the combination of blank 16, web reclosure material 55 and zipper material 54), still in a flat unfolded configuration, are separated from each other and stacked, or otherwise prepared for subsequent transportation and/or assembly. An alternate embodiment may use web reclosure material 44 with transverse perforated lines (or other lines of weakness) between subsequent cartons 1000 so as to form a continuous belt of blank boxes with attached web reclosure material, and which are then stacked in a zig-zag configuration on top of each other.

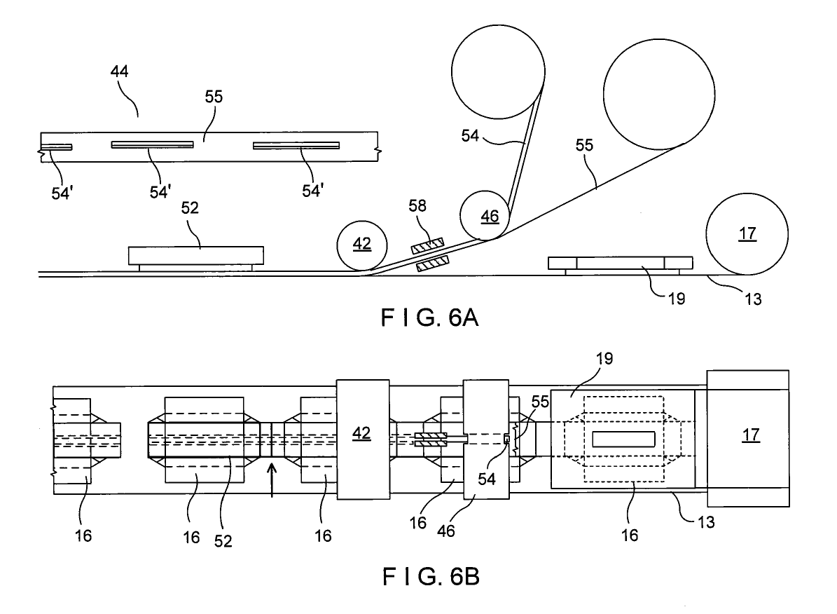

Alternative embodiments are shown in FIGS. 6A and 6B wherein the stock rigid or semi-rigid material 13 of blanks 16 is provided from spool 17 and cut and shaped at shaping station 19 to form blanks 16. In this illustrated embodiment, initially the center section and the unusable sides of the rigid or semi-rigid stock material are cut out, and the various score lines (for subsequent folding) are formed. The central section that joins successive blanks 16 is also scored to keep the unfolded blanks attached to each other until they are later separated. However, if the blanks 16 are completely separated, side rollers can be used to move them from one station to another. FIG. 6A further includes an inset with an illustration of an alternative embodiment wherein the web reclosure material 44 is provided with pre-applied zipper sections or segments 54′ which are then indexed to fit over the blanks 16.

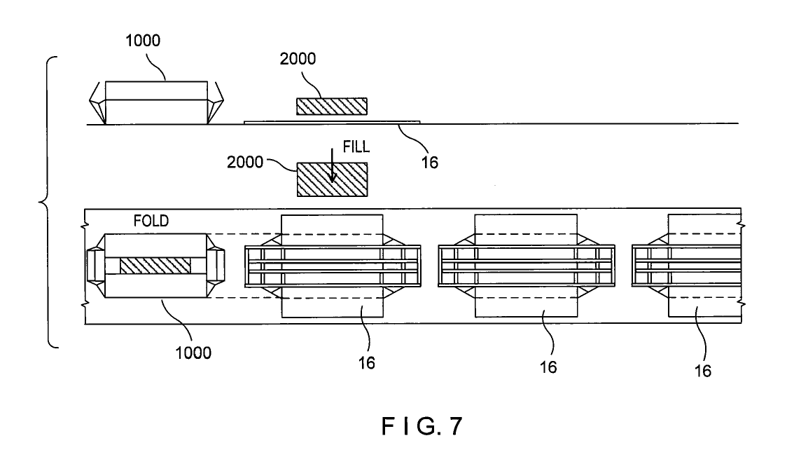

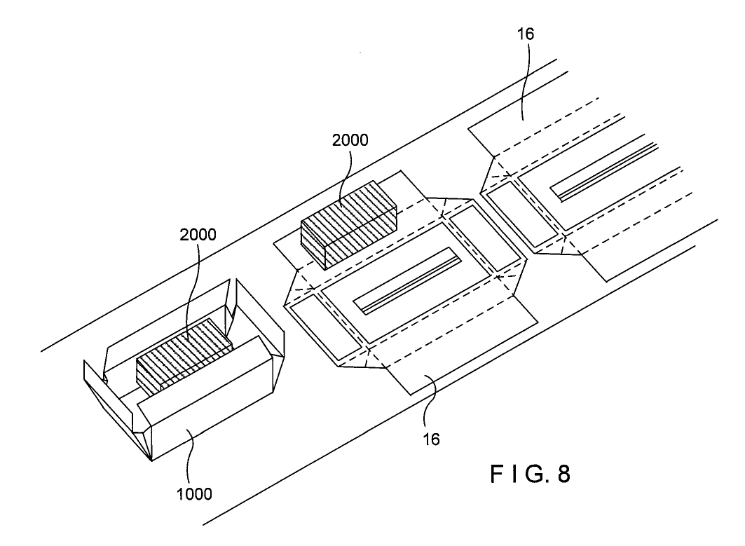

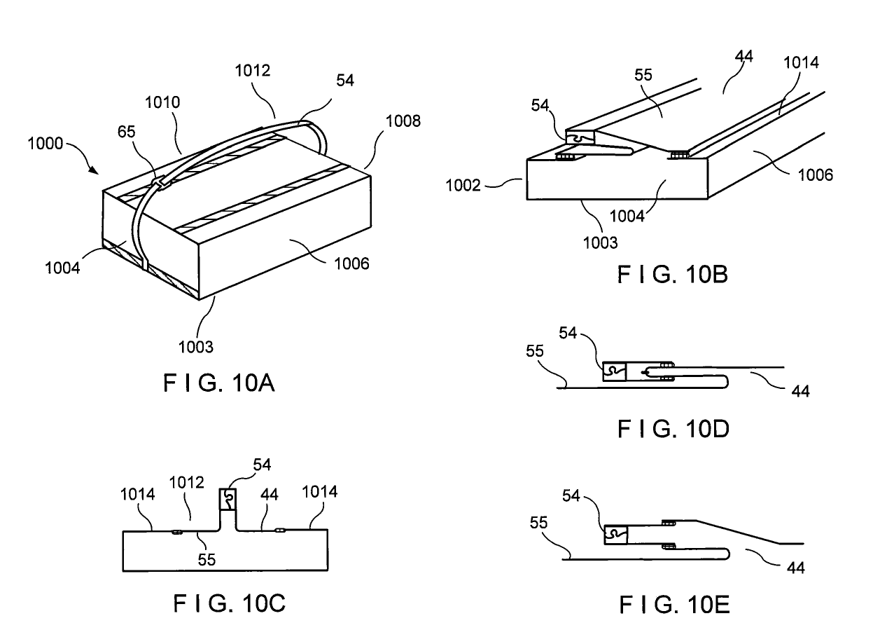

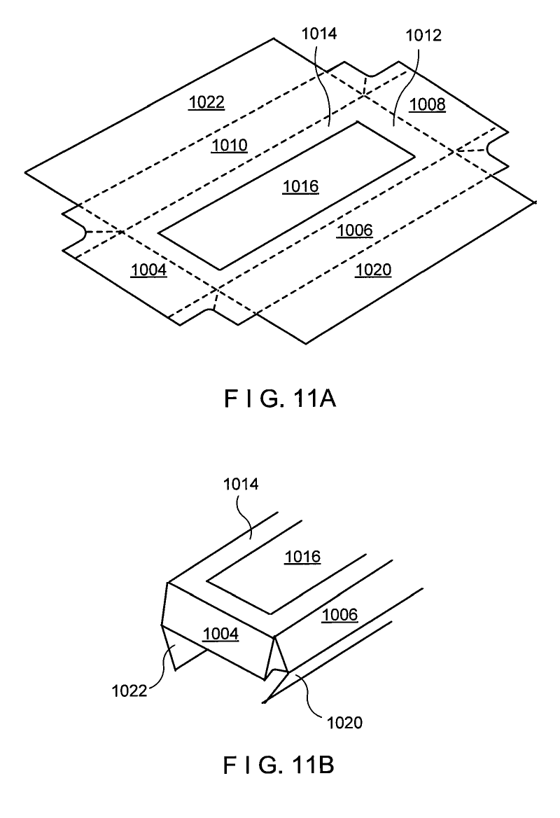

Subsequently, as shown in FIGS. 7 and 8, at the same location or at a different location, including a different or separate geographic location, a form-and-hill operation will take place wherein the flat cartons 1000, including the blank 16, the web reclosure material 44 and the zipper material 54 will be folded to form the completed cartons 1000 with a storage volume. FIGS. 7 and 8 illustrate the filling of the cartons 1000. The unfolded box blanks 16 with attached web reclosure material 44 are loaded from the side with contents 2000 after which the side and bottom panels are folded and attached to each other to form the filled carton 1000. Alternately, the bottom flaps of the carton 1000 can be folded, closed and attached to each other and the filling done through the zipper or other reclosure 54. In any event, the filled carton 1000 is typically provided with tamper-evident construction. In some instances, one of the zipper flanges may be left at least partially unattached or unsealed to the web material at a specific location or opening, the unit filled through that unattached area opening, after which the zipper flange and the web reclosure material are re-attached and sealed to each other thereby closing the opening. The resulting packages are shown in FIG. 9A-9F, and 10A-10E wherein completed cartons 1000 have a rigid or semi-rigid bottom 1003 (formed from flaps 1020, 1022 in FIGS. 11A and 11B), four rigid or semi-rigid sides 1004, 1006, 1008, 1010 and top 1012 comprising a rigid or semi-rigid frame-type structure 1014 around a central opening 1016 which is covered with web reclosure material 44 and zipper 54. Additionally, as shown in FIG. 9E, a band 1018 can be placed around and attached to the carton 1000. Similarly, as shown in FIG. 9F, a cardboard or similar rigid or semi-rigid lid 1100 can be placed over the top of carton 1000 in order to protect the contents, provide further tamper evidence, and further aid in the shipping and storage of cartons 1000. As shown in FIGS. 9A-9F and 10A-10F, the sealing or attachment of the web reclosure material 44 to the completed carton 1000 takes place on one side of the panel (the top) or three panels (two sides and top, i.e. on an uneven number of panels of carton 1000). Additionally, as shown in FIGS. 9D, 10B, 10D and 10E, the web reclosure material 44 can, after attachment, be configured to be folded flat against the top 1012 of carton 1000.

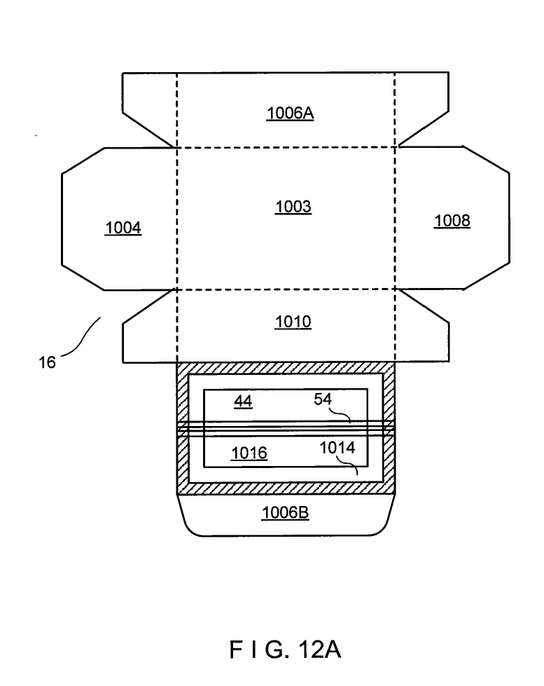

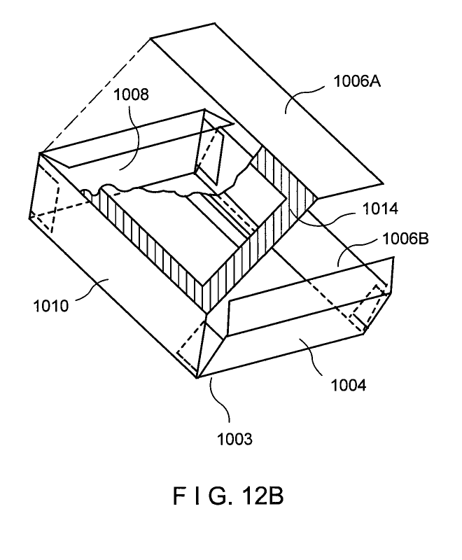

The blanks 16 may be made of carton or fibrous materials, rigid or semi-rigid polymers, or any other rigid or semi-rigid materials. The blanks 16 may be coated or laminated on either side or both with polymers, may provide moisture or oxygen barriers, or may be biodegradable. As shown in FIGS. 12A and 12B, the blanks 16 may have any number of panels and many different arrangements of bottom flaps and different was of folding and attaching these together to form the bottom of the container 1000. The various panels are separated by score lines to provide for accurate folding of the blank 116 thereby forming the container. While typically, only one panel of the blank 16 may require an opening such as central opening 1016, more openings would be provided and, while the web reclosure material 44 would typically be attached only to an uneven number of sides, there are applications wherein it may also be attached to an even number of sides of the blank 16.

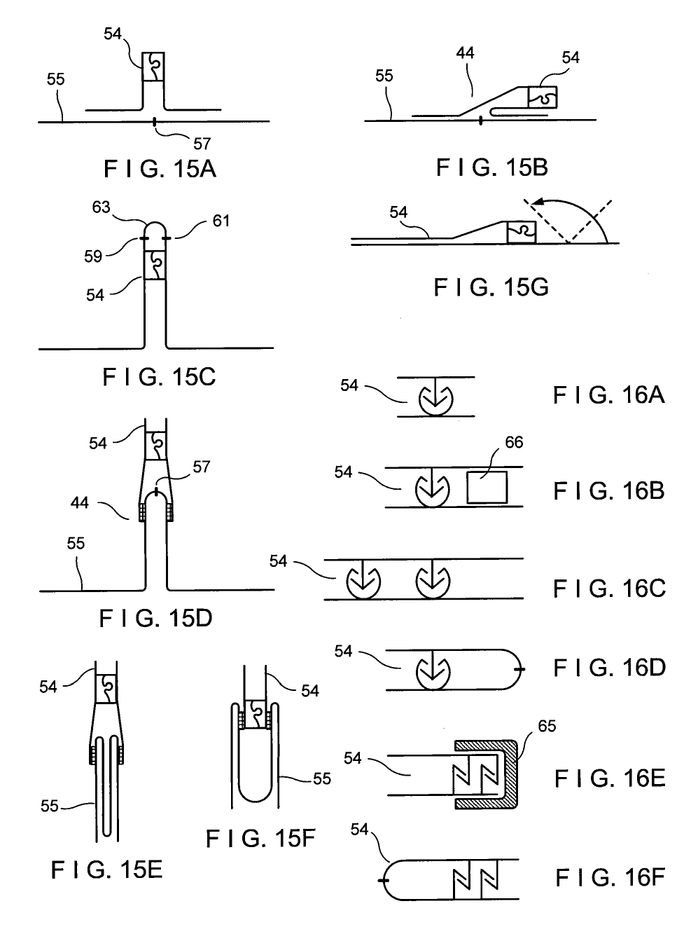

The web and reclosure mechanism and/or zipper 55 may be delivered attached to each other from a spool or assembled in front of the machine from separate reclosure and web material spools (see FIGS. 5A and 5B). The web material 55 is typically flexible polymeric material, which may include, but is not limited to, polyethylene, polypropylene or other polymers. The web material could have eyemarks, be delivered in a flat or folded configuration, have folds above or below the zipper 54 or both, wherein the folds could then be provided with features such as handles, tear-away compartment, spouts or funnels, be provided with tear lines or lines of weakened resistance, or be provided with peel seal material. When the web material 55 and the zipper 54 are delivered attached to each other, the zipper could be attached to the web reclosure material in separate, discrete sections, in which case the zipper 54 could be attached to the web material in the film-delivered direction (i.e., machine direction) or at an angle to the Film-delivered direction, such as the transverse direction. If the web material 55 is delivered in one web, it will have a tear line 57 (see FIGS. 15A and 17) or line of weakened resistance below the zipper 54 to provide access to the contents 2000 of the carton 1000. The tear line 57 will typically be formed in the machine direction, with a first interlocking element of zipper 54 attached to the web reclosure material 44 on a first side of the tear line 57 and a second interlocking element of zipper 54 attached to web material 55 on a second side of tear line 57. However, if the web material 55 is delivered as two webs 55′, 55″, as shown in FIG. 5, there is no need for such a line of weakness as access is provided between the two webs.

The zipper or reclosure material 54 is typically a zipper, but may also include hook-and-eye or adhesive constructions. The zipper 54 may have on of many constructions such as, but not limited to, a zipper operated by a slider 65 (see FIGS. 10A and 16E), a zipper with flanges above or below the zipper (the flanges of which may or may not be attached to each other, and may include tear lines 59, 61 as shown in FIG. 15C, the zipper structure being formed as shown in FIG. 15G). A string zipper, a double zipper, a tamper-evident zipper, a zipper with bent or uneven length flanges, a zipper with pre-applied spot seals, a zipper with a line of weakened resistance, a zipper with a peel seal (see peel seal 66 in FIG. 16B), a leak-resistant zipper, a zipper with wedges, a zipper with stabilizing post, a zipper with guide ribs, a pinch grip pull zipper or a clicker zipper may also be implemented. The zipper 54 could be attached to the web material 55 in several different ways, from above or below the web material as illustrated in FIGS. 10D, 10E, 13A, 14A, 15D and 15E. Additionally, particularly if the web material 55 is delivered as a single web, the zipper 54 may be placed astride a line of weakness 57 as shown in FIG. 15D.

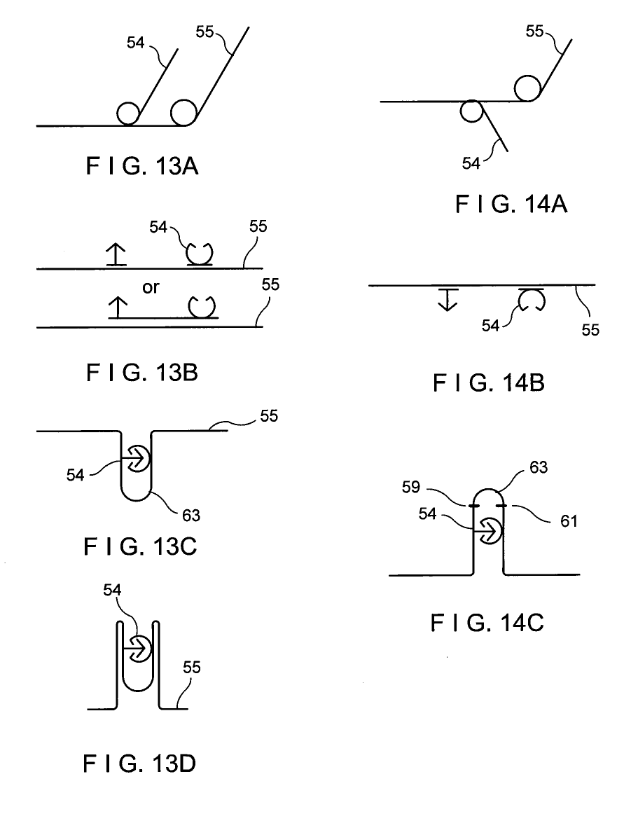

The zipper 54 can be delivered interlocked or in unlocked, separated sections, and can have several variations. The zipper 54 can be attached to a flat web material 55 as shown in FIG. 15A, or to a web material 55 with a pre-formed fold 63 and tear-lines 59, 61 above the interlocking zipper elements as shown in FIG. 15C. If the zipper 54 delivered separate and unlocked, it can be delivered from above or below the web material 55 as shown in FIGS. 13A and 14A, after which, when the zipper 54 is aligned and interlocked, a fold 63 is formed above or below the zipper 54, as shown in FIGS. 13C and 14B. Alternately, zipper 54 can be delivered with different flange arrangements such as shown in FIGS. 15A and 15B, so as to be positioned in a stand-up configuration above the web material 55. Typically, the zipper base (if a string zipper) or the zipper flanges are attached to the web material 55 at different times. The resulting construction is the same, but the method and sequence of attachment of the zipper 54 to the web material 55 is different. If a fold 63 is formed in the web material 55 as previously indicated, the zipper 54, instead of being attached to the inside of the fold 63, can be attached to the outside of the fold 63, so that the fold 63 is positioned below the zipper interlocking elements and the zipper flange. Typical zipper configurations illustrative of this are shown in FIGS. 15D and 15E.

In this way, a container 1000 is provided.

Thus the several aforementioned objects and advantages are most effectively attained. Although preferred embodiments of the invention have been disclosed and described in detail herein, it should be understood that this invention is in no sense limited thereby and its scope is to be determined by that of the appended claims.

What is claimed is:

1. A method of manufacturing a container with a rigid or semi-rigid box section and a flexible reclosure, comprising the steps of:
providing a series of rigid or semi-rigid unfolded flat box sections, each of the box sections being capable of being folded thereby forming a plurality of panels around a storage volume:
providing a length of web reclosure material; and
attaching the length of web reclosure material to the flat unfolded box section.

2. The method of claim 1 wherein the flat box sections include perforations for removing a portion of the box section thereby providing a cut-out section.

3. The method of claim 1 wherein the flat box section includes a cut-out section.

4. The method of claim 3 wherein the step of attaching the length of web reclosure material to the flat unfolded box section covers the cut-out section of the box section.

5. The method of claim 4 wherein the unfolded flat box sections include a plurality of score lines thereby defining a plurality of panels.

6. The method of claim 5 wherein the length of web reclosure material is attached to one panel of the plurality of panels of each flat box section.

7. The method of claim 5 wherein the length of web reclosure material is attached to an uneven number of panels of the plurality of panels of each flat box section.

8. The method of claim 3 wherein the step of providing the length of web reclosure material includes the steps of providing a length of reclosure material, providing a length of flexible web material, and attaching the reclosure material to the flexible web material.

9. The method of claim 8 wherein the reclosure material is a zipper.

10. The method of claim 9 wherein the zipper includes a peel seal.

11. The method of claim 9 wherein the zipper includes at least one line of weakened resistance.

12. The method of claim 9 wherein the zipper includes a slider.

13. The method of claim 9 further including the step of attaching the slider to the zipper before the step of attaching the zipper to the flexible web material.

14. The method of claim 9 further including the step of attaching the slider to the zipper after the step of attaching the zipper to the flexible web material.

15. The method of claim 9 wherein the zipper is continuously attached to the flexible web material.

16. The method of claim 9 wherein the zipper is attached to the flexible web material in discrete sections.

17. The method of claim 16 wherein the discrete section of zipper are attached to the flexible web material in the machine direction.

18. The method of claim 16 wherein the discrete section of zipper are attached to the flexible web material in the transverse direction.

19. The method of claim 9 wherein the zipper includes interlocking elements and the zipper is attached to the flexible web material with the interlocking elements interlocked.

20. The method of claim 9 wherein the zipper includes interlocking elements and the zipper is attached to the flexible web material with the interlocking elements unlocked.

21. The method of claim 9 wherein the step of providing the web reclosure material includes the step of providing the reclosable flexible web material as a single sheet.

22. The method of claim 9 wherein the step of providing the flexible reclosable material includes the step of providing the flexible web material as two sheets.

23. The method of claim 9 further including the step of forming a fold in the web material and wherein the step of attaching the zipper to the flexible web material includes the step of attaching the zipper within the fold in the web material.

24. The method of claim 9 further including the step of forming a fold in the web material and wherein the step of attaching the zipper to the flexible web material includes the step of attaching the zipper on an outside of the fold in the web material.

25. The method of claim 9 further including the step of forming a plurality of folds in the flexible web material.

26. The method of claim 21 wherein the single sheet of flexible web material includes a tear line.

27. The method of claim 26 wherein the zipper includes first and second interlocking elements and wherein the first interlocking element is attached to the single sheet of flexible web material on a first side of the tear line and a second interlocking element is attached to the single sheet of flexible web material on a second side of the tear line.

28. The method of claim 9 further including the step of cutting the reclosable flexible web material between successive box sections, thereby providing individual unfolded flat box sections.

29. The method of claim 28 further including the step of placing contents on the flat box section and the folding the box panels around the contents, thereby forming containers with contents in a storage volume.

30. The method of claim 28 further including the step of folding the box panels, thereby forming containers with a storage volume.

31. The method of claim 30 including the step of inverting the container, filling the container with contents through an open bottom of the container, and folding bottom panels of the box sections to close the bottom of container.

32. The method of claim 28 including the step of filling the container with contents through the web reclosure material.

33. The method of claim 29 including the steps of placing contents on the unfolded flat box sections, thereafter folding the panels of the flat box sections around the filled contents and attaching the panels together.

34. The method of claim 28 further including a step of filling the container with contents, wherein the step of filling the container is geographically separate from the steps of the steps of providing a length of reclosure material, providing a length of flexible web material, and attaching the reclosure material to the flexible web material.

35. The method of claim 30 further including placing a lid on a top of the container.

36. The method of claim 30 further including placing a band around the container.

37. The method of claim 9 wherein the zipper includes a tamper-evident structure.

38. The method of claim 28 wherein the step of attaching the reclosable material to the flexible web material leaves an opening between the reclosable material and the flexible web material, and further including the steps of filling the container through the opening with contents and sealing the opening.

39. The method of claim 1 wherein the series of rigid or semi-rigid unfolded flat box sections is formed from a continuous length of rigid or semi-rigid material.
